(19) United States
(12) Patent Application Publication
(10) Pub. No.: US 2017/0030510 A1
(43) Pub. Date: Feb. 2, 2017

(54) PHOTOCATALYTIC THERMAL BARRIER COATING

(71) Applicant: Thomas Dunlap, Purcellville, VA (US)

(72) Inventor: Thomas Dunlap, Purcellville, VA (US)

(21) Appl. No.: 15/290,463

(22) Filed: Oct. 11, 2016

Related U.S. Application Data
(63) Continuation-in-part of application No. 14/721,974, filed on May 26, 2015.

(51) Int. Cl. F16L 59/08; B01J 35/00; B01J 21/06; C09D 5/00

(52) U.S. Cl. CPC F16L 59/08; C09D 5/00; B01J 35/004; B01J 35/0013; B01J 21/063

(57) ABSTRACT

A thermally insulated photocatalytic coating is provided. The photocatalytic coating includes a photocatalyst material capable of being activated by irradiation with a light source. Further, the photocatalytic coating includes a thermal barrier compound adapted to reduce temperature of the photocatalytic material for increasing efficiency of the photocatalytic layer. The present invention also relates to various articles, such as CFL lamps and bulbs, which have the coating applied thereon. These articles are very helpful in eliminating various impurities from ambient air.

### FIELD OF INVENTION

This present invention relates to photocatalytic materials, and, more particularly, to highly efficient photocatalytic coatings having a thermal barrier.

### BACKGROUND

Photoreactions refer to chemical reactions induced by light. One type of photoreaction is photocatalysis. In a typical photocatalytic process, light is absorbed by an adsorbed substrate to create electron-hole pairs, which generate free radicals (e.g. hydroxyl radicals: .OH) along with oxygen. These free radicals are able to undergo very useful secondary reactions. For example, the free radicals are able to react with organic contaminants to decompose them. Therefore, such a reaction has an ability to clean air, wherein offensive, odourus, harmful gases, or the like, are decomposed to harmless forms leading to a reduction in the quantity of these unwanted elements in the surroundings.

Various materials have been used for photocatalytic process. Suitable materials include, but are not limited to, titanium dioxide, tungsten oxide, strontium titanate, zinc oxide (TiO2, TiO2:N (VLR), TiO2:C (VLR), ZnO, WO3, SrTiO3). Usually, such photocatalytic materials absorb Ultraviolet (UV)* radiation from sunlight or illuminated light source (fluorescent lamps), thereby producing electrons and holes. The electron of the valence band of the transition element becomes excited when illuminated by light. The excess energy of this excited electron promotes the electron to the conduction band of the transition element therefore creating the negative-electron (e−) and positive-hole (h+) pair. The photocatalytic oxidation of an organic species often proceeds via adsorption of the pollutant on the surface of the catalyst, followed by direct subtraction of the pollutant's electrons by positively charged holes. Another possible way is oxidation with OH radicals, generated from water of the aqueous environment, which takes place at the catalyst surface or in its vicinity. Both reactions may proceed simultaneously and which mechanism dominates depends on the chemical and adsorption properties of the pollutant. Therefore, it will be appreciated that there is a reasonable need to improve the photocatalysis process so as to provide means to clean pollutants from ambient air.

One of the important photocatalysts is Titanium dioxide (TiO2). It is one of the most researched semiconductor oxides that has revolutionized technologies in the field of environmental purification and energy generation. It has found extensive applications in heterogenous photocatalysis for removing organic pollutants from air and water and also in hydrogen production from photocatalytic water-splitting. Its use is popular because of its low cost, low or non-toxicity, high chemical and thermal stability, excellent optical and electronic properties. TiO2 has been used for environmental remediation purposes such as in the purification of water and air and also in the solar water splitting. Photocatalysis is by far one of the most superior technologies in the environmental purification because unlike many other technologies, photocatalysis does not serve as a mere phase transfer but completely degrades the organic pollutants by converting to innocuous substances such as CO2 and H2O.

Theoretically photocatalytic activity is affected by many factors such as phase structure, crystallinity, surface hydroxyl density and oxygen vacancies. Particle size also facilitated the photocatalytic reaction. Finer the size, higher is the photocatalytic performance. Photocatalytic performance of titania coatings further varies based upon the thermal spray techniques employed such as atmospheric plasma spraying (APS), suspension plasma spraying (SPS) and high-velocity oxygen fuel spray process (HVOF).

Various ways are known for improving the utility of the photocatalysis process. For example, the utility of the process could be increased by developing new and better photocatalytic materials, which have better rates of cleaning the pollutants. Yet another way includes finding out efficient ways of increasing the practicability of such a process so as to make it easily available commercially.

Although much progress has been made in the development of new materials, there exists at present no single material which can withstand all the extreme operating conditions in modern technology, so that, the combined properties of the composite system may satisfy a particular set of operating conditions.

In view of one or more limitations of the present solutions described above, there is a need for an improved photocatalysis process for variety of applications.

### SUMMARY

In one embodiment, the present invention discloses a thermally insulated photocatalytic coating, which includes a photocatalyst material capable of being activated by irradiation with a light source. Further, the photocatalytic coating includes a thermal barrier compound adapted to reduce temperature of the photocatalytic material for increasing efficiency thereof.

In another embodiment, the present invention discloses an article comprising a base substrate coated with a thermally insulated photocatalytic coating. In various embodiments, the base substrate is an incandescent light source. In various embodiments, the light sources are at least one of a fluorescent bulbs, incandescent light, and light emitting diodes.

These aspects together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawing and descriptive matter in which there is illustrated an exemplary embodiment of the present invention.

### BRIEF DESCRIPTION OF THE DRAWINGS

FIG. 1 illustrates a block diagram of thermally insulated photocatalytic coatings, according to an embodiment of the present invention;

FIG. 2 illustrates a block diagram of thermally insulated photocatalytic coatings, according to another embodiment of the present invention; and

FIG. 3 illustrates an article having a base substrate 310 with thermally insulated photocatalytic coatings disposed thereon, according to various embodiments of the present invention.

Skilled artisans will appreciate that elements in figures are illustrated for simplicity and clarity and have not necessarily been drawn to scale. For example, the dimensions of some of the elements in the figures may be exaggerated, relative to other elements, to help improving an understanding of the embodiments of the present invention.

There may be additional structures described in the foregoing application that are not depicted on one of the described drawings. In the event such a structure is described, but not depicted in a drawing, the absence of such a drawing should not be considered as an omission of such design from the specification.

### DETAILED DESCRIPTION OF INVENTION

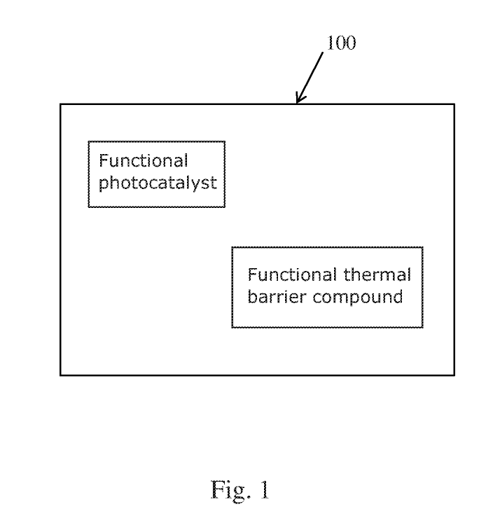

The following detailed description is merely exemplary in nature and is to enable any person skilled in the art to make and use the invention. The examples shown in description are not intended to limit the application and uses of the various embodiments. Various modifications to the disclosed invention will be readily apparent to those skilled in the art, and the methodology defined herein may be applied to other embodiments and applications without departing from the spirit and the scope of the present disclosure. Thus, the present invention is not limited to the examples discussed below, but is to be accorded the widest scope consistent with the methodology and features disclosed herein. It should also be noted that FIGS. 1 to 3 are merely illustrative and may not be drawn to scale.

The exemplary embodiments described herein detail for illustrative purposes are subject to many variations in composition or processes herein described. It should be emphasized, however, that the present invention is not limited to the compositions, techniques and articles herein described.

The terms “a” and “an” herein do not denote a limitation of quantity, but rather denote the presence of at least one of the referenced item.

The terms “having”, “comprising”, “including”, and variations thereof signify the presence of a component.

The present invention relates to thermally insulated photocatalytic coatings, and more particularly, to a photocatalytic coating having a photocatalyst with an inert thermal barrier in the same substance. It should be understood by a person skilled in the art that a thermal barrier coating is usually designed to protect a surface on which it is applied from a high temperature, by increasing the resistance to heat transfer. Such coatings have low thermal conductivities and are deposited onto a variety of surfaces of metal parts, particularly those exposed to high temperature gradients.

The thermally insulated photocatalytic coating (interchangeably called “Photocatalytic Thermal Barrier Coating” or “PTBC”) of the present invention is adapted to reduce surface temperature thereof as the Infra Red (IR) radiation, when impinged there upon, is reflected back into space rather than absorbed by the surface, thereby lowering the surface temperature and accordingly increasing adsorption of water molecules. This increases the rate of production of hydroxyl radicals and thus increases the effectiveness of the photocatalyst.

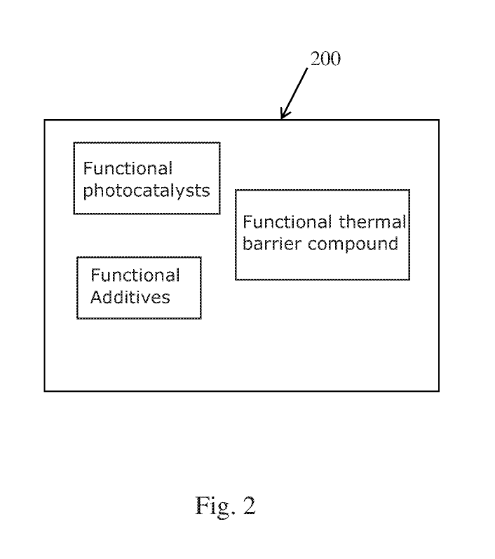

For reference purpose, the PTPC coating as per embodiments of the invention are illustrated as PTBC coating 100 in FIG. 1 and PTBC coating 200 in FIG. 2.

In various embodiments of the present invention, the PTBC coating is created by blending a thermal barrier compound chemical nanoparticle, such as indium tin oxide (ITO) or antimony tin oxide (ATO) or ceramic particles (for non-transparent coating applications), to existing titanium dioxide, tungsten oxide, strontium titanate, zinc oxide, (TiO2, TiO2:N (VLR), TiO2:C (VLR), ZnO, WO3, SrTiO3) or other photocatalyst (so it could be a variety of photocatalytic materials) in order to increase the thermal reflectivity of the coating thereby combining the attributes of both compounds into a single solution. However, such examples of the photocatalyst material and the barrier compounds should not be construed as a limitation to the present invention.

In various embodiments of the present invention, the thermal barrier compound and the photocatalyst material are combined in various ratios.

In various embodiments of the present invention, the photocatalyst coating may be added with various additives for enhancing one or more characteristic properties of the coating.

In various embodiments of the present invention, the photocatalyst coating may be added with various adhesives for enhancing adhesion of the coating on various base substrates.

Further, the photocatalyst coatings use UV-activated photocatalysts for exterior applications and visible light responsive (VLR) photocatalysts for interior applications. The thermal barrier coatings of the present invention utilize nanoparticles like ITO/AZO or hollow glass microspheres (HGMs) or ceramic particles. The thermal barrier compound has thermal reflective properties. hi certain embodiments, the thermal barrier compound may include an albedo reflection coefficient between about 0.25 and about 0.75, such as about 0.4 and about 0.6, or about 0.5.

In various embodiments of the present invention, both photocatalyst coatings and thermal barrier, could also be applied separately. The photocatalyst coating is applied last so that the photocatalyst nanoparticles have access to the surface. Once the photocatalyst nanoparticules have access to adsorbed water molecules, they produce the hydroxyl (OH) radicals for the disinfectant action.

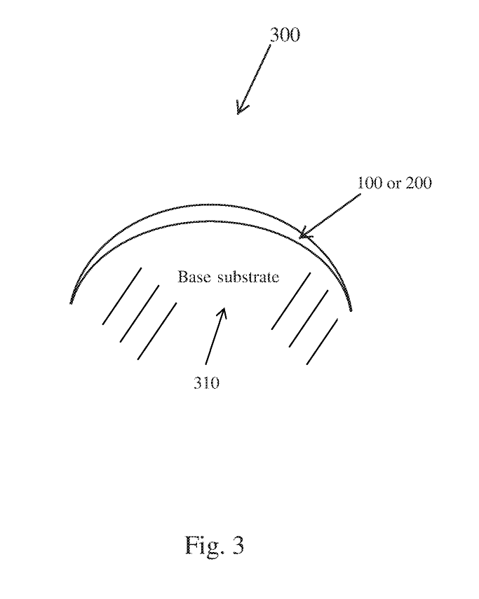

The use of the thermally insulated photocatalyst coatings will now be described. The photocatalyst coating is firstly applied to various substrates. Again for reference this is illustrated in FIG. 3 where PTBC coating 100 or 200 is shown to be applied over a base substrate 310.

When the coatings are applied for exterior applications, sunlight will activate the photocatalyst materials, in the coatings. This produces desirable effects such as air purification (via OH radicals), bacteriostatic/hygienic surfaces (OH radicals kill microorganisms), and “self-cleaning” (superhydrophilic) surfaces. The photocatalyst particles are activated by the ultraviolet (UV) portion of the solar spectrum or in some cases by the visible portion of the solar spectrum.

Usually, the IR radiation in the impinging radiation causes the surface temperature to rise. On the other hand, photocatalysts need access to water molecules to produce hydroxyl radicals in order to realize the beneficial effects described above. The concentration of water molecules adsorbed on the surface usually depends on the surface temperature. The higher the surface temperature the lower the adsorption and the less effective the photocatalyst. The lower the surface temperature the higher the adsorption the more effective the photocatalyst. For indoor applications, light sources such as fluorescent bulbs (including compact fluorescent bulbs), incandescent light, LEDs, etc. are sufficient to activate visible light responsive (VLR) photocatalyst materials.

The combination of a photocatalyst with an inert thermal barrier in the same substance would reduce surface temperature significantly as the IR is reflected back into space rather than absorbed by the surface, thereby lowering the surface temperature thereby increasing adsorption of water molecules, increasing production of hydroxyl radicals and thus increasing the effectiveness of the photocatalyst.

The process of producing the coatings involves the following steps:
a. A combination of functionalized indium tin oxide (ITO) and/or antimony tin oxide (ATO) nanoparticles are added with functionalized TiO2 titanium dioxide nanoparticles so they are both water and organic solvent soluble.
b. Thereafter, the combination having the particles are added to a water-based or organic-based coating base (an organic-based solvent which would evaporate could be used, and the inorganic coating left on the surface).

The PTBC coating is targeted to improve radiation resistance in the applied coating, durability of TiO2 to which it is combined with, and lower surface temperature and increase efficiency of all TiO2 variants.

The thermally insulated coatings of the present invention may be in form of liquid or powder. Further, the combined thermal barrier and photocatalyst compound may be mixed with variety of other substances for applications. Suitable examples of these applications may include:
a. White paint or other white base for improving heat reflectivity/infrared reflectivity.
b. Other color paint or clear coat liquid substances.
c. Roof, siding and ground/paver application, after market application to roofs (green application—environmental AND reduction of microbes/roof algae, so called “roof bacteria”)
d. Roof shingles—further allowing roof companies to use lower concentrations of asphalt while avoiding “roof bacteria” when mixing PTBC with the product.
e. Aircraft, automobiles, other vehicles.
f. Paved and concrete surfaces.
g. Building materials, sidings, and the like.

The coatings as explained above have various other applications. Such applications can include improvements on all current photocatalytic uses where heat transference or reduced surface or internal temperature would be a benefit in the application. The coatings combine air cleaning, particle and dirt repellent qualities (super-hydrophilic attributes) of photocatalysts with heat/thermal reflectivity properties, thereby increasing the usefulness of the new coating over conventional photocatalytic coatings.

Some examples include application on plastic, metal, glass and ceramic surfaces, exterior surfaces and glass surfaces of vehicles such as cars, trucks and buses, railcars, shipping containers, residential and commercial roofs, architectural construction materials such as wood, brick, vinyl and aluminum siding, asphalt shingles, windows, concrete and asphalt pavement, and the like.

Further, the combined photocatalyst and thermal barrier coating would also have military applications to reduce infrared signatures of military vehicles, artillery, aircraft and naval ships.

In addition to all the beneficial properties of conventional photocatalytic coatings, this coating would also reflect infrared radiation (heat) so that surface temperatures would be significantly reduced.

One significant advantage of the PTBC is reduction in cooling costs combined with “green” hygienic and anti-microbial and anti-pollutant benefit by reduction of heat absorption when applied to siding and roofing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

We claim:

1. A thermally insulated photocatalytic coating comprising:
at least one photocatalyst material capable of being activated by an irradiation from a light source; and
at least one thermal barrier compound comprising a reflection coefficient of about 0.25 and up to about 0.75, and thereby adapted to reduce temperature of the photocatalytic material.

2. The thermally insulated photocatalytic coating of claim 1, wherein the photocatalyst material comprises photocatalytic nanoparticles.

3. The thermally insulated photocatalytic coating of claim 1, wherein the photocatalyst material is selected from a group comprising titanium dioxide, tungsten oxide, strontium titanate, and zinc oxide.

4. The thermally insulated photocatalytic coating of claim 1, wherein thermal barrier compound comprises thermal barrier nanoparticles.

5. The thermal insulated photocatalytic coating of claims 1, wherein the thermal barrier compound is selected from a group comprising indium tin oxide (ITO), antimony tin oxide (ATO) or ceramic particles.

6. The thermal insulated photocatalytic coating of claim 1, wherein the light source is at least one of a fluorescent bulb, a fluorescent bulb, incandescent light, and Light Emitting Diode (LED).

7. An article comprising a base substrate coated with the thermally insulated photocatalytic coating of claim 1.

8. The article of claim 7, wherein the base substrate is an incandescent light source.

9. The article of claim 8, wherein the incandescent light source is at least one of a fluorescent bulb, an incandescent light, and a light emitting diode.

10. The article of claim 7, wherein the base substrate is at least one of a glass substrate, a ceramic substrate, and an architectural construction material.
